(19) United States
(12) Patent Application Publication
(10) Pub. No.: US 2025/0383436 A1
(43) Pub. Date: Dec. 18, 2025

(54) MONITORING BODY MOVEMENTS USING ULTRA WIDE BAND (UWB) SIGNALS

(71) Applicant: NXP B.V., Eindhoven (NL)

(72) Inventors: Matteo Ridolfi, Gentbrugge (BE); Filippo Casamassima, Thal (AT); Vincent Pierre Martinez, VENERQUE (FR)

(21) Appl. No.: 18/797,322

(22) Filed: Aug. 7, 2024

(30) Foreign Application Priority Data
Jun. 17, 2024 (EP) 24305949.0

(51) Int. Cl. G01S 13/52; G01S 13/02

(52) U.S. Cl. CPC G01S 13/52; G01S 13/0209

(57) ABSTRACT

Monitoring object movement comprises attaching an ultra-wide band (UWB) sensor to an object and transmitting, by the UWB sensor in a radar mode, a plurality of UWB pulses. The UWB sensor in the radar mode receives a plurality of reflected UWB pulses and determines over a time a channel response (CIR) based on the plurality of transmitted and reflected UWB pulses. The CIR is indicative of the object movement.

### CROSS-REFERENCE TO RELATED APPLICATIONS

This application claims the priority under 35 U.S.C. § 119 of European Provisional Patent application no. 24305949.0, filed on 17 June 2024, the contents of which are incorporated by reference herein.

### TECHNICAL FIELD

Embodiments of the subject matter described herein generally relate to ultra-wide band (UWB) signals and in particular monitoring body movements using UWB signals.

### BACKGROUND

Various sports now rely on wearing inertial measurement units (IMUs) which are electronic devices with sensors such as one or more of global navigation satellite systems (GNSS), accelerometers, and gyroscopes, among other types of sensors, to gather data associated with body movement of a human engaged in physical activities such as an athlete who is training for a sport or in competition. This data which could include one or more of a position, speed or velocity, acceleration, and angular motion of the body movement over time is used to understand strengths and weakness of the human when engaged in the body movement, improve his performance, and minimize risk of injury during the body movement. The data is communicated using a wireless communication to a host device for analysis.

### BRIEF DESCRIPTION OF THE DRAWINGS

A complete understanding of the subject matter may be derived by referring to the detailed description and claims when considered in conjunction with the following figures, wherein like reference numbers refer to similar elements throughout the figures.

FIG. 1 illustrates a block diagram of an example ultra-wide band (UWB) sensor in accordance with an embodiment.

FIGS. 2A & 2B illustrate respectively a graph of an example average channel impulse response (CIR) amplitude determined based on UWB sensing as a function of CIR bins and CIR amplitude plotted as a function of time for different CIR bins in accordance with an embodiment.

FIG. 3 illustrates an example of another CIR amplitude determined based on UWB sensing plotted as function of time for different CIR bins in accordance with an embodiment.

FIG. 4 illustrates an example of yet another CIR amplitude determined based on UWB sensing plotted as a function of time for different CIR bins in accordance with an embodiment.

FIG. 5 is a flow chart of functions associated with using the UWB sensor to monitor movement in accordance with an embodiment.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

Conventional sensors for measuring body movement of a human engaged in a physical activity are prone to error. Accuracy of the sensors also need to be calibrated over time to compensate for drift. Further the drift of the sensors could change based on speed or velocity of the body movements while other sensors might show poor reaction or latency.

Embodiments disclosed herein are directed to an ultra-wide band (UWB) sensor which is configured in a radar mode to detect body movement. The UWB sensor is worn on a body such as an arm, leg, head, or shoulder to determine data indicative of one or more of a position, speed or velocity, acceleration, and angular motion, of the body movement over time. The UWB sensor transmits UWB pulses which are received as reflected UWB pulses and used to determine a channel impulse response (CIR) indicative of the body movement. The CIR is then analyzed to determine a characteristic or type of the body movement without a need to compensate for drift and without privacy issues of using cameras to compensate for this drift. In some examples, CIRs could be combined to determine relative movement between body parts and body movement relative to the ground or other objects. The UWB sensor may also be configured in a communication mode to transfer data indicative of the CIR to a host device via a UWB transceiver for analysis rather than relying on another transceiver such as a cellular or WiFi modem to perform the data transfer. The UWB sensor may also configured in a ranging mode to determine a range to another UWB node based on a communication with the other UWB node. The UWB sensor which operates in one or more of the communication mode, a radar mode, and ranging mode defines an all-in-one solution for detecting and communicating body movement which is simple to design with a small form factor, power efficient, and low cost. Well known structures and techniques have not been shown in detail in order not to obfuscate the description.

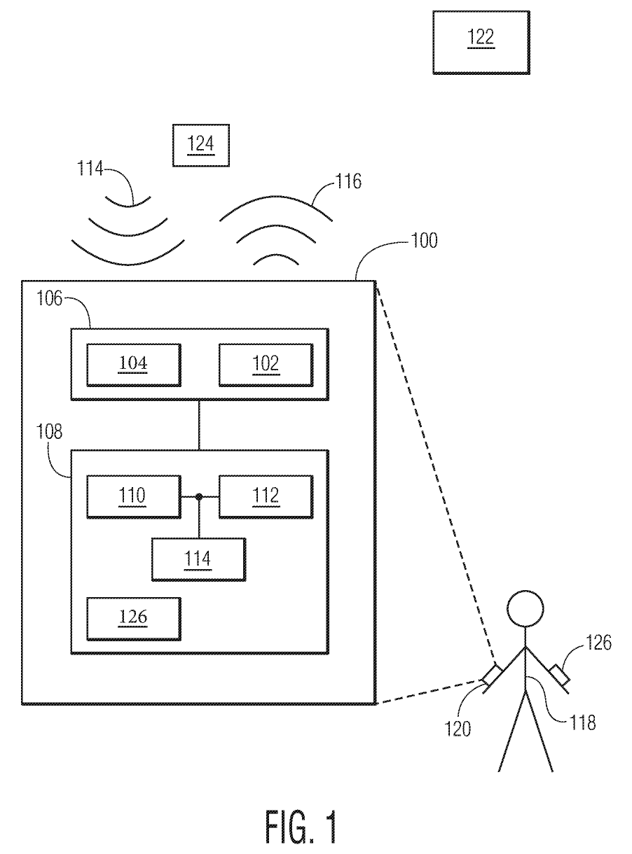

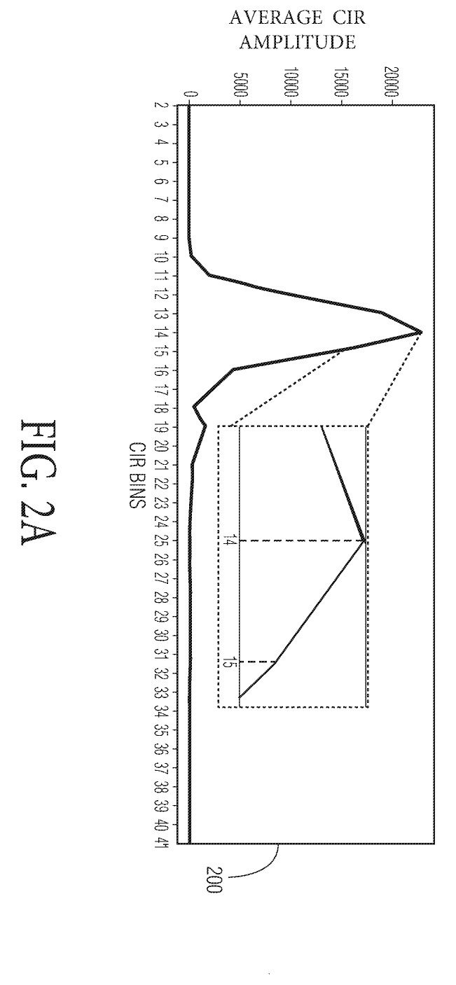

FIG. 1 illustrates a block diagram of an example ultra-wide band (UWB) sensor 100 in accordance with an embodiment. The UWB sensor 100 includes a UWB transceiver 106 and a host processor 108. In an example, the UWB sensor 100 may be attached by a strap in an example to a body 118 of a human engaged in physical activity such as an arm 120. In examples, the UWB sensor 100 may be used to determine body movement of the body 118 to which the UWB sensor 100 is attached. Operation of the UWB sensor 100 is described herein in a context of being attached to the human body as an illustration of the use of the UWB sensor 100 but in general, the UWB sensor 100 may be attached to an object, live or inanimate, to determine object movement and embodiments are not limited to where the UWB sensor 100 is attached and the movement which is monitored.

The UWB transceiver 106 may transmit and receive UWB signals. To facilitate this transmission and reception, the UWB transceiver 106 may have a transmitter 102 and a receiver 104. The transmitter 102 may transmit UWB signals 116 and the receiver 104 may receive reflected UWB signals 104 from an object in an environment where the UWB sensor 100 is located. The host processor 108 may have radar circuitry 110, ranging circuitry 112, communication circuitry 114, and memory 126 in an example. The circuitry 102-114 and memory 126 may be implemented as one or more of analog circuitry, mix signal circuitry, memory circuitry, logic circuitry, and processing circuitry that executes code stored in a memory that when executed by the processing circuitry performs the disclosed functions.

In one example, the radar circuitry 110 may configure the UWB sensor 100 in the radar mode where the transceiver 106 may transmit the UWB signal 116 in the form of a plurality of UWB pulses such as UWB impulses. The UWB pulses have a bandwidth of several hundred megahertz, which gives this technology its name. In an example, the UWB pulses may be transmitted by a transmitter 102 in a frame 124 such as in a preamble of the frame 124. A receiver 104 may then receive the reflected UWB signal 114 which in an example is a plurality of reflected UWB pulses that the radar circuitry 110 correlates with the respective transmitted UWB pulses. The radar circuitry 110 may use transmitted and reflected pulses that are correlated to determine a channel impulse response (CIR) which is stored in the memory 126. A CIR can be understood as energy of pulse responses received at the receiver 104 plotted over time which correlate to corresponding UWB pulses transmitted by the transmitter 102. The CIR may describe how a wireless channel responds to each of the transmitted UWB pulses and is indicative of a reflector in an environment such as an object or the ground in the environment. The radar circuitry 110 may also perform processing of the CIR to characterize the body movement in terms of position, speed or velocity acceleration, or angular motion as examples. In an example, the radar circuitry 112 may perform conventional radar processing to determine these parameters. In some examples, CIRs could be combined to determine relative movement between body parts and body movement relative to ground or other objects. The CIR may also be analyzed to determine a type of the body movement such as whether the body movement is standing still, jumping, or squatting as examples.

In another example, the communication circuitry 114 may configure the UWB sensor 100 in a communication mode. The communication mode may be defined by a standard such as 802.15.4z (Enhanced Impulse Radio) which defines a physical layer (PHY) and media access control sublayer (MAC) for pulse radio ultra-wideband (UWB) wireless ad-hoc connectivity. In the communication mode, the transmitter 102 may transmit an indication of the CIR to a remote host device 122 as a UWB signal for processing instead of or in addition to being performed by the radar circuitry 110. Further, the UWB sensor may use the UWB transceiver 106 to transmit the CIR and not need another transceiver to such as a Bluetooth transceiver or WiFi transceiver to transmit the CIR. In an example, the remote host device 122 may perform conventional radar processing to characterize the body movement in terms of position, speed or velocity acceleration, or angular motion as examples. The CIR may also be analyzed to determine the type of the body movement. In some examples, CIRs could be combined to determine relative movement between body parts and body movement relative to ground or other objects.

In yet another example, the ranging circuitry 112 may configure the UWB sensor 100 in a ranging mode. In a ranging mode, the transceiver 106 may transmit a message to a UWB node 126. In some examples, the UWB node 126 might be attached to another part of the body 118 such as the UWB sensor 100 attached to one arm and the UWB node 126 attached to another arm of the body 118. The UWB node 126 may have circuitry to provide a response to the message which is used to determine a range or relative movement between different parts of the body to which the UWB sensor 100 and UWB node 126 are attached. A time of flight based on a time of transmission of the message and arrival of the response is indicative of a range or relative movement between the UWB sensor 100 and the UWB node 126 and provides a more accurate positioning compared to determining positioning in the radar mode which does not require that the UWB node 126 transmit a response to the frame 122. Processes for ranging may be defined by the FiRa Consortium and Car Connectivity Consortium, as examples.

The UWB sensor 100 which operates in one or more of the communication mode, radar mode, and ranging mode defines an all-in-one solution for monitoring body movement. The UWB sensor 100 is power efficient, cheaper, smaller, and simple to design compared to global navigation satellite systems (GNSS), accelerometers, and gyroscopes, among other sensors, to gather data associated with body movement. Further, these same conventional sensors need to have a separate transceiver for communicating the data associated with the body movement, including Bluetooth transceivers or WiFi transceivers compared to the UWB sensor 100 which has a single UWB transceiver 106 to perform the radar, sensing, and wireless communication.

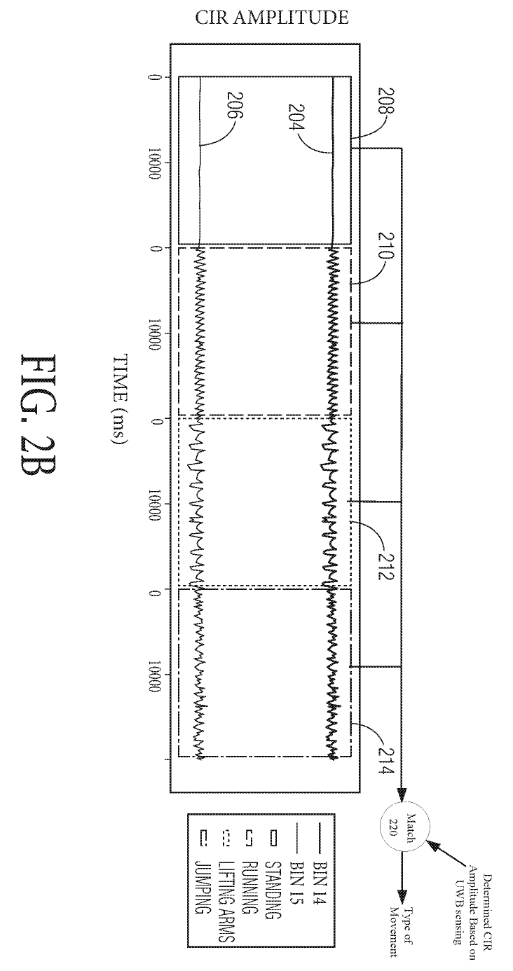

FIGS. 2A & 2B illustrate respectively a graph of an example average channel impulse response (CIR) amplitude determined based on UWB sensing as a function of CIR bins and a CIR amplitude plotted as a function of time for different CIR bins in accordance with an embodiment. In an example, the UWB sensor 100 may transmit one or more frames with a preamble which has a one or more UWB pulses and receive reflected UWB pulses. Transmitted and corresponding received UWB pulses are correlated to determine the CIR. Each CIR is associated with one or more bins which is indicative of the reflected UWB pulses received at a time, indicative of particular distance of an object which reflects the transmitted pulse, and as N which is an integer index of bin number increases the time when the reflection is received is longer and the reflecting object is further away. A CIR may be determined for an activity such as standing still, running in spot, lifting arms, and jumping. The CIR may typically include a phase and amplitude as a function of time, but the CIR phase is not illustrated for simplicity in the examples described herein. Principles described with respect to CIR amplitude may be extended to CIR phase without limitation to determine of the body movement or improve determination of the body movement.

Graph 200 in FIG. 2A is a CIR which illustrates an average CIR amplitude measured over time as a function of CIR bins. The graph may include a self-interference period resulting from the receiver 104 directly receiving after a period of time the UWB pulses that was transmitted by the transmitter 102 without reflection in the environment followed by receipt of UWB pulses reflected by objects in an environment. For example, CIR bin 14 indicates an average peak self-interference for the transceiver 104 followed by CIR bins 14-41 where an average CIR amplitude is illustrated for each bin index. Various activities such as standing still, running in spot, lifting arms, and jumping may result in a similar graph 200, but the CIR amplitude in a CIR bin may be different for different activities.

FIG. 2B shows a plot of CIR amplitude in CIR bins for different activities performed during a period of time. Different activities may be performed for 20 seconds in the example and the CIR amplitude measured for a bin during the time is plotted. Window 208 shows the CIR amplitude as a function time (i.e., 20 seconds) for standing still in CIR bins 14, 15 shown by upper plot 204 and lower plot 206 respectively. Further, window 210 shows the CIR amplitude as a function of time (i.e., 20 seconds) for running in place in CIR bins 14, 15 shown by upper plot 204 and lower plot 206, window 212 shows the CIR amplitude as a function of time (i.e., 20 seconds) for jumping for CIR bin 14, 15 shown by upper plot 204 and lower plot 206, and window 214 shows the CIR amplitude as a function of time (i.e., 20 seconds) for standing still but lifting arms for CIR bins 14, 15 shown by upper plot 204 and lower plot 206.

The CIR amplitude for each bin are based on the movement being performed for a period of time with a clear different and reproducible pattern which allows for classifying the movement. As a result, CIR amplitude patterns indicative of different types of movement may be used to identify a type of movement. The UWB sensor 100 may be configured in the communication mode and the CIR amplitude determined based on the UWB sensor 100 operating in the radar mode may be transmitted from the UWB sensor 100 to the remote host device 122 by the UWB sensor 100. The remote host device 122 may then determine a type of movement associated with the determined CIR amplitude. The remote host device 122 may store respective CIR amplitude patterns of different activities which are identified in a training phase of the UWB sensor 100. The determined CIR amplitude which is transmitted based on UWB sensing in a radar mode may be provided to a matching circuit 220 which then determines to which of the CIR amplitude patterns indicative of a movement the determined CIR amplitude matches (e.g., has a correlation which meets a threshold level). Based on the matching, the determined CIR amplitude is also indicative of the movement and the remote host device 122 outputs an indication of the type of movement sensed by the UWB sensor 100. For example, if the determined CIR amplitude matches the CIR amplitude pattern of jumping in a CIR bin, then the determined CIR amplitude indicates a jumping movement. In an example, the remote host device 122 may perform signal processing or even machine learning to determine from a CIR amplitude pattern of a type of movement whether a determined CIR amplitude for which a type of movement is unknown is associated a particular type of movement such as standing still, running in a spot, jumping, and standing and lifting arms, among other activities.

In some examples, the determination of the type of movement may be performed locally on the UWB sensor 100 rather than by the remote host device 122. The radar circuitry 110 may determine a type of movement associated with the determined CIR amplitude. The memory 126 may store the CIR amplitude patterns of different activities. If the determined CIR amplitude matches one of the CIR amplitude patterns indicative of a movement, the determined CIR amplitude is also indicative of the movement and classifies the determined CIR amplitude with the type of movement.

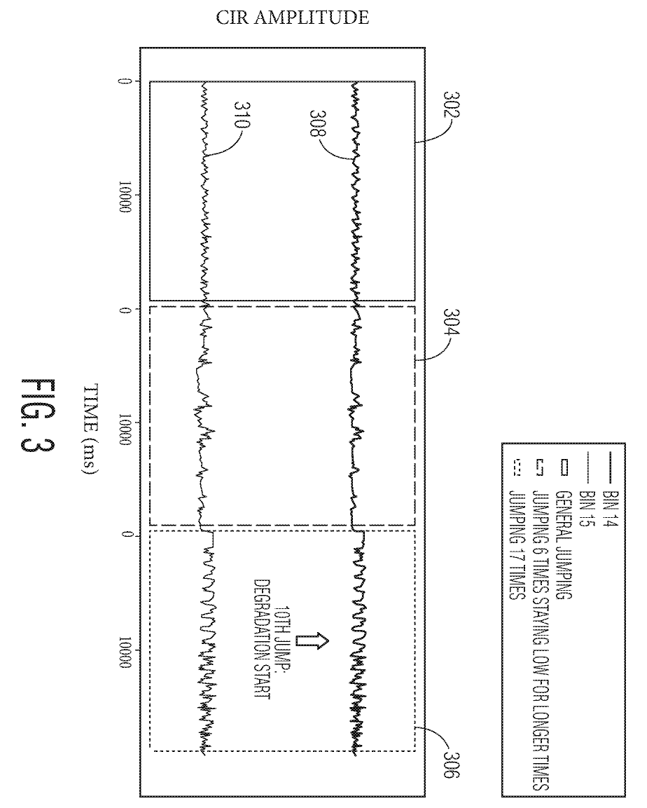

FIG. 3 illustrates an example of another CIR amplitude determined based on UWB sensing plotted as function of time for different CIR bins in accordance with an embodiment. In an example, the CIR may be used to determine one or more body movement, such as on one or more of a position, speed or velocity, acceleration and angular motion, and orientation.

In an example, the CIRs may be associated with a jumping movement in the spot, a jumping and staying low with knees bent, and jumping for a total of seventeen jumps. CIR amplitude is plotted for CIR bins 14 and 15. Window 302 shows the CIR amplitude as a function of time for jumping for CIR bins 14 and 15 shown by upper plot 308 and lower plot 310 respectively. Further, window 304 shows the CIR amplitude as a function of time for jumping and knees bent in a squatting position in CIR bins 14, 15 shown by upper plot 308 and lower plot 310 respectively and window 306 shows the CIR amplitude as a function of time for jumps in CIR bins 14, 15 shown by upper plot 308 and lower plot 310 respectively for a total of seventeen jumps. The CIR for a movement may vary over time indicating changes in the movement. For example, the CIR amplitude in window 306 shows a consistent pattern for 10 jumps but then the pattern in the 10^{th} jump degrades which indicates that the jumping is performed slower or less high and not performed in a consistent manner. As another example, the CIR amplitude in window 304 shows an irregular pattern of jumping from the squat position where the last jumps may be lower than the earlier jumps, and a timing between jumps may not be consistent. In an example, the UWB sensor 100 may communicate the CIR amplitude to the remote host device 122 which identifies a characteristic of the body movement such as one or more of a position, speed, velocity, acceleration, angular motion, and orientation of the body movement based on conventional signaling processing or machine learning.

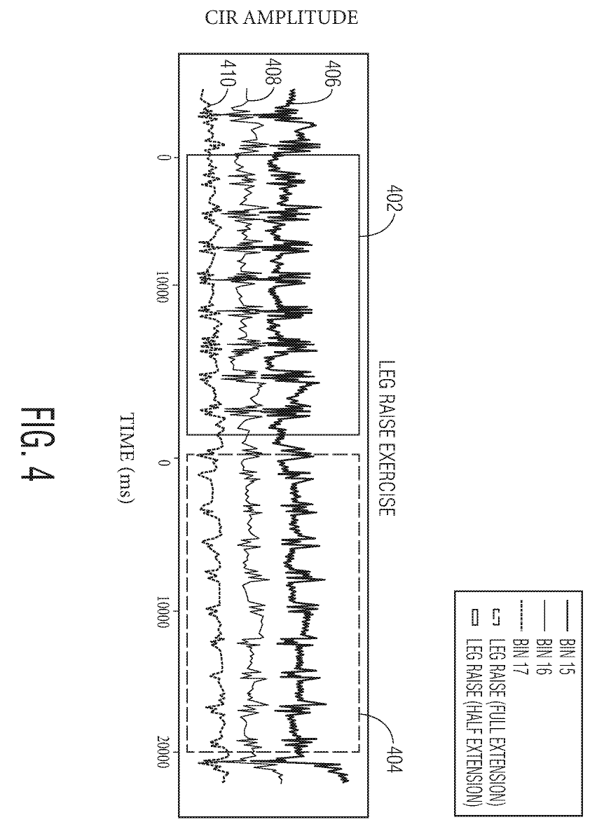

FIG. 4 illustrates an example of yet another CIR amplitude determined based on UWB sensing plotted as function of time for different CIR bins in accordance with an embodiment. In an example, a UWB sensor 100 attached to one body part may be used to monitor another body part not attached to the UWB sensor 100. For example, a UWB sensor 100 mounted on one arm may be used to monitor movement of another arm or leg or vice versa which does not have the UWB sensor 100. Window 402 illustrates CIR amplitude for CIR bins 15, 16, 17 shown as plots 406, 408, 410 respectively, which are associated with a standing leg raise with half extension where the UWB sensor 100 is worn on a standing leg. Window 404 illustrates CIR amplitude for CIR bins 15-17 shown as plots 406, 408, 410 respectively which are associated with a leg raise with full extension where the UWB sensor 100 is worn on a standing leg. The CIR amplitude in CIR bins 15-17 versus CIR bins 14-15 may be used for illustration in this example because a distance from the UWB sensor 100 to the other leg may be greater, and more time is needed to receive the reflected UWB pulses which corresponds to the CIRs received in CIR bins 15-17. The CIR amplitude for two different movements in window 402, 404 with the UWB sensor 100 attached to the same standing leg indicates that the CIR amplitude may be used to determine movement of other body parts, which in this example, is a leg moving either partially or fully. Further, a difference between the CIR amplitude on the standing leg with no motion (window 208 in FIG. 2) and the CIR amplitude with the motion of another body part may be used to further determine relative motion of the other body part, including detection, characterization, and classification of the body movement. Further, signaling processing or even machine learning may be used to determine from the CIR amplitude in one or more CIR bins movement of body parts other than the one to which the UWB sensor 100 is attached. The sensing by the UWB sensor 100 minimizes a number of UWB sensors needed to perform the monitoring since the one UWB sensor is able to monitor movement of other body parts.

In examples, the CIR is illustrated by CIR amplitude as a function of time. In other examples, the CIR may be illustrated in addition by a CIR phase as a function of time. The use of the CIR phase may be used in combination with the CIR amplitude to determine a type of body movement and characteristic of the body movement. For example, determined CIR phase based on the UWB sensing may be compared to respective CIR phase patterns associated with different activities to determine an activity associated with the determined CIR phase. In yet other examples, the determined CIR phase may be used instead of the determined CIR amplitude to determine the type of body movement.

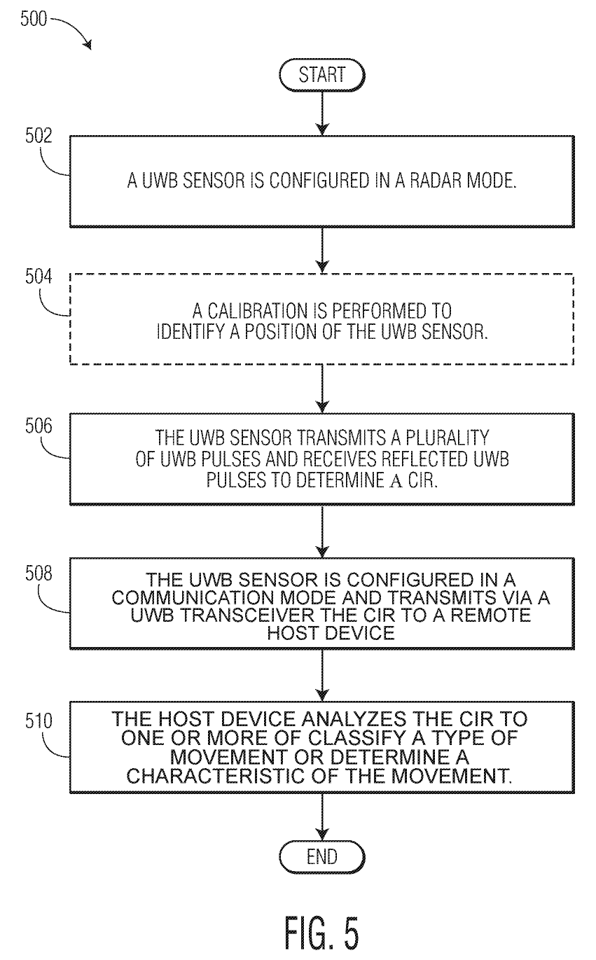

FIG. 5 is a flow chart 500 of functions associated with using a UWB sensor to monitor movement in accordance with an embodiment. The CIR which are determined based on the UWB sensor 100 being attached to a body and which is defined by one or more of CIR amplitude and CIR phase may be used to determine one or more of a type of body movement, identify characteristics of the body movement, and monitor movement of a part of a body other than to which the UWB sensor 100 is attached. The CIR may be used for other purposes as well.

At 502, a UWB sensor is configured in a radar mode. In the radar mode, the UWB sensor senses a characteristic of movement or type of movement of objects in an environment such as a body as an example.

At 504, a calibration is performed to identify a position of the UWB sensor. The position might include height and orientation of the UWB sensor with respect to the ground in an example. The calibration may be manual or automatic. The manual calibration may include configuring the UWB sensor with the position or using the UWB sensor to automatically perform the calibration. For example, the manual calibration may be for a user to specify the position of the UWB sensor with respect to the ground or the UWB sensor in a radar mode may perform a UWB sensing to determine its position with respect to the ground. Further, in some instances a UWB sensor may not perform the calibration. For this reason, the calibration step 504 is illustrated as a dotted box to indicate that it is optional.

At 506, the UWB sensor transmits a plurality of UWB pulses and receives reflected UWB pulses to determine a CIR. The CIR may be indicative of a movement of the body or objects arranged around the body. The CIR may be represented by one or more of CIR amplitude or CIR phase and be a function of bin.

At 508, the UWB sensor is configured in a communication mode and transmits the CIR to a remote host device. The UWB sensor may use its UWB transceiver to transmit the CIR and not need another transceiver to such as a Bluetooth transceiver or WiFi transceiver to transmit the CIR.

At 510, the remote host device analyzes the CIR which was transmitted to one or more of classify a type of movement or determine a characteristic of the movement. The analysis may include determining a relative movement of a body part different from the body part to which the UWB sensor is attached or relative movement to ground. The analysis may include identifying a pattern in the CIR by comparing to a reference CIR pattern indicative of a type of movement to determine a type of movement of the CIR which was transmitted based on a correlation that exceeds a threshold amount. The analysis may also include using the CIR to determine characteristics of the movement of the UWB sensor by measuring variations in amplitude or phase of the CIR over time. The analysis may also include determining position and velocity of the UWB sensor. In a doppler mode, the host device may apply a 1-dimensional (D) or 2-D Fast Fourier Transforms (FFT) to the CIR to determine a velocity of the body movement. In a non-doppler mode, the host device 108 may not perform the FFT, outputting the CIR instead to another processor or server in the cloud which performs the subsequent required signal processing operations, such as 1-D or 2-D FFT and machine-learning to determine the velocity of the body movement. In an example, the analysis may be based on CIR amplitude of the CIR or CIR phase of the CIR. Advantageously, the UWB sensor is arranged in a radar mode to classify a movement and determine characteristics of the movement using a single UWB sensor rather than using different sensors or sensors that need to communicate in a ranging mode to determine position or distance in an example. Further, the UWB transceiver of the UWB sensor may be used to transmit the CIR to the remote host device 122 rather than using a separate wireless transceiver which operates with a different protocol to communicate the CIR. The UWB sensor is also less prone to drift and can also be used for UWB ranging in a ranging mode in addition to operating in the radar mode and communication mode.

In some examples, the radar circuitry on the UWB sensor may be arranged to perform analysis of the CIR rather than the remote host device. Step 508 may not be performed in this example and instead the UWB sensor rather than the host device may perform the analysis. For example, the UWB sensor may operate in the doppler mode and perform the FFT of the CIR to determine the velocity of the body movement and transmit the results to the host device 124 for further processing rather than being performed by the remote host device. In other examples, analysis may be performed by both the radar circuitry on the UWB sensor and the remote host device.

The term CIR as used herein may refer to a CIR which is determined for a period of time for a plurality of CIR bins or a portion of a CIR which is determined a period of time and which corresponds to a bin of the CIR.

In an embodiment, a method for monitoring object movement is disclosed. The method comprises: attaching an ultra-wide band (UWB) sensor to an object; transmitting, by a transceiver of the UWB sensor in a radar mode, a plurality of UWB pulses; receiving, by the transceiver of the UWB sensor in the radar mode, a plurality of reflected UWB pulses; determining over a time a channel impulse response (CIR) based on the transmitted plurality of UWB pulses and reflected UWB pulses; and determining the object movement based on the CIR. In an example, the object is a body, and the object movement is movement of a body part to which the UWB sensor is attached. In an example, the object is a body, and the object movement is movement of a body part to which the UWB sensor is not attached. In an example, the object is a body and the object movement is body movement, the method further comprising determining movement of a part of the body to which the UWB sensor is attached based on a ranging performed with a UWB node attached to another part of the body. In an example, the method further comprises arranging the UWB sensor in a communication mode and transmitting by a UWB transceiver the CIRs to a remote host device to determine the object movement. In an example, determining the object movement comprises comparing the CIR to a CIR pattern indicative of a particular type of object movement to determine the body movement indicated by the CIR. In an example, the ranging comprises transmitting by the transceiver a ranging request to a UWB node; receiving by the transceiver a ranging response to the ranging request; and determining a distance from the UWB sensor to the UWB node based on a time of flight between transmission of the request and reception of the response. In an example, the method further comprises determining a characteristic of the movement based on the CIR. In an example, the object movement is based on one or more of an amplitude and phase of the CIR over the time.

In another embodiment, a UWB sensor attached to an object for monitoring object movement is disclosed. The UWB sensor comprises a UWB transceiver arranged in a radar mode to transmit a plurality of UWB pulses and receive, by the transceiver a plurality of reflected UWB pulses to the transmitted plurality of UWB pulses; and radar circuitry arranged to determine over a time a channel impulse response (CIR) based on the plurality of transmitted UWB pulses and reflected UWB pulses and determine based on the CIR the object movement to which the UWB sensor is attached. In an example, the object is a body, and the object movement is movement of a body part to which the UWB sensor is attached. In an example, the UWB sensor further comprises communication circuitry arranged to cause the UWB transceiver to transmit the CIR to a remote host device to determine the object movement. In an example, the object is a body and the object movement is body movement, the UWB sensor further arranged to determine movement of a part of the body to which the UWB sensor is attached based on a ranging performed with a UWB node attached to another part of the body. In an example, the UWB sensor further comprises ranging circuitry arranged to determine movement of the body part to which the UWB sensor is not attached by determining the movement of the body part to which the UWB sensor is attached based on a ranging performed with a UWB node attached to the body. In an example, the ranging circuitry is arranged to cause the transceiver to transmit a ranging request to a remote host device; receive by the transceiver a ranging response to the ranging request; and determine by the ranging circuitry a distance from the UWB sensor to the remote host device based on a time of flight between transmission of the request and reception of the response. In an example, the UWB sensor further comprises the radar circuitry arranged to determine a characteristic of the object movement based on the CIR. In an example, the object movement is based on one or more of an amplitude and phase of the CIR over the time In yet another embodiment, a remote host device is disclosed. The remote host device comprises: a transceiver arranged to receive a CIR from a UWB sensor attached to an object; and radar circuitry arranged to determine movement of the object based on the CIR received from the UWB sensor. In an example, the radar circuity is arranged to compare the CIR to a CIR pattern indicative of a particular type of object movement to determine the object movement indicated by the CIR. In an example, the radar circuity is arranged to determine a characteristic of the movement based on the CIR.

For the sake of brevity, conventional semiconductor fabrication techniques may not be described in detail herein. In addition, certain terminology may also be used herein for reference only, and thus are not intended to be limiting, and the terms “first”, “second” and other such numerical terms referring to structures do not imply a sequence or order unless clearly indicated by the context.

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with) another element, and not necessarily mechanically. Thus, although the schematic shown in the figures depict one exemplary arrangement of elements, additional intervening elements, devices, features, or components may be present in an embodiment of the depicted subject matter.

Although the operations of the method(s) herein are shown and described in a particular order, the order of the operations of each method may be altered so that certain operations may be performed in an inverse order or so that certain operations may be performed, at least in part, concurrently with other operations unless expressly indicated. In another embodiment, instructions or sub-operations of distinct operations may be implemented in an intermittent and/or alternating manner.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for monitoring object movement, the method comprising:
attaching an ultra-wide band (UWB) sensor to an object;
transmitting, by a transceiver of the UWB sensor in a radar mode, a plurality of UWB pulses;
receiving, by the transceiver of the UWB sensor in the radar mode, a plurality of reflected UWB pulses;
determining over a time a channel impulse response (CIR) based on the transmitted plurality of UWB pulses and reflected UWB pulses; and
determining the object movement based on the CIR.

2. The method of claim 1, wherein the object is a body, and the object movement is movement of a body part to which the UWB sensor is attached.

3. The method of claim 1, wherein the object is a body, and the object movement is movement of a body part to which the UWB sensor is not attached.

4. The method of claim 1, wherein the object is a body and the object movement is body movement, the method further comprising determining movement of a part of the body to which the UWB sensor is attached based on a ranging performed with a UWB node attached to another part of the body.

5. The method of claim 1, further comprising arranging the UWB sensor in a communication mode and transmitting by a UWB transceiver the CIRs to a remote host device to determine the object movement.

6. The method of claim 1, wherein determining the object movement comprises comparing the CIR to a CIR pattern indicative of a particular type of object movement to determine the body movement indicated by the CIR.

7. The method of claim 1, wherein the ranging comprises transmitting by the transceiver a ranging request to a UWB node; receiving by the transceiver a ranging response to the ranging request; and determining a distance from the UWB sensor to the UWB node based on a time of flight between transmission of the request and reception of the response.

8. The method of claim 1, further comprising determining a characteristic of the movement based on the CIR.

9. The method of claim 1, wherein the object movement is based on one or more of an amplitude and phase of the CIR over the time.

10. A UWB sensor attached to an object for monitoring object movement comprising:
a UWB transceiver arranged in a radar mode to transmit a plurality of UWB pulses and receive, by the transceiver a plurality of reflected UWB pulses to the transmitted plurality of UWB pulses; and
radar circuitry arranged to determine over a time a channel impulse response (CIR) based on the plurality of transmitted UWB pulses and reflected UWB pulses and determine based on the CIR the object movement to which the UWB sensor is attached.

11. The UWB sensor of claim 10, wherein the object is a body, and the object movement is movement of a body part to which the UWB sensor is attached.

12. The UWB sensor of claim 10, further comprising communication circuitry arranged to cause the UWB transceiver to transmit the CIR to a remote host device to determine the object movement.

13. The UWB sensor of claim 10, wherein the object is a body and the object movement is body movement, the UWB sensor further arranged to determine movement of a part of the body to which the UWB sensor is attached based on a ranging performed with a UWB node attached to another part of the body.

14. The UWB sensor of claim 10, further comprising ranging circuitry arranged to determine movement of the body part to which the UWB sensor is not attached by determining the movement of the body part to which the UWB sensor is attached based on a ranging performed with a UWB node attached to the body.

15. The UWB sensor of claim 14, wherein the ranging circuitry is arranged to cause the transceiver to transmit a ranging request to a remote host device; receive by the transceiver a ranging response to the ranging request; and determine by the ranging circuitry a distance from the UWB sensor to the remote host device based on a time of flight between transmission of the request and reception of the response.

16. The UWB sensor of claim 10, further comprising the radar circuitry arranged to determine a characteristic of the object movement based on the CIR.

17. The UWB sensor of claim 10, wherein the object movement is based on one or more of an amplitude and phase of the CIR over the time.

18. A remote host device comprising:
a transceiver arranged to receive a CIR from a UWB sensor attached to an object; and
radar circuitry arranged to determine movement of the object based on the CIR received from the UWB sensor.

19. The remote host device of claim 18, wherein the radar circuity is arranged to compare the CIR to a CIR pattern indicative of a particular type of object movement to determine the object movement indicated by the CIR.

20. The remote host device of claim 18, wherein the radar circuity is arranged to determine a characteristic of the movement based on the CIR.
